(19) United States
(12) Patent Application Publication
(10) Pub. No.: US 2020/0060438 A1
(43) Pub. Date: Feb. 27, 2020

(54) SHELF COVERING SYSTEMS

(71) Applicant: Stein Industries, Inc., Brooklyn Park, MN (US)

(72) Inventors: Mark David Chenoweth, Hamel, MN (US); Nathan L. Westby, Zimmerman, MN (US); Christopher John Reed, Coon Rapids, MN (US)

(21) Appl. No.: 16/357,911

(22) Filed: Mar. 19, 2019

Related U.S. Application Data
(60) Provisional application No. 62/722,603, filed on Aug. 24, 2018.

(51) Int. Cl. A47F 5/00; A47F 5/01; G09F 3/20

(52) U.S. Cl. CPC A47F 5/0068; G09F 3/204; A47F 5/01

(57) ABSTRACT

This document provides product display systems for displaying merchandise. Exemplary product display systems described herein includes a side support and a fence configured to be coupled to a wire shelf and a price channel configured to be coupled to the fence. In some cases, the system also can include a wire shelf cover.

### CLAIM OF PRIORITY

This application claims priority under 35 USC § 119(e) to U.S. Patent Application Ser. No. 62/722,603, filed on Aug. 24, 2018, the entire contents of which are hereby incorporated by reference.

### TECHNICAL FIELD

This document relates to product display systems, such as coverings for shelving, for displaying merchandise.

### BACKGROUND

Product display systems and shelves are used by retailers for displaying a variety of products to consumers. A variety of different product display systems are used by retailers, including wire shelves. Often, retailers use the same type of shelving for a variety of different products. However, not all products are suited for display using the same type of shelving. For example, small products, products with a small base, or products with other unique shapes may be unsuited to sit well on wire shelving.

### SUMMARY

This document provides product display systems, such as coverings for shelving, for displaying merchandise. In some cases, shelf covering systems described herein can be used to display products to consumers. For example, products displayed on shelf covering systems described herein can include, without limitation, refrigerated food products and frozen food products. In some cases, product display systems described herein can be used to display non-food items to consumers.

In one aspect, this document features a product display system that includes a side support, a fence, and a price channel configured to be coupled to a wire shelf. In some cases, the system also can include a wire shelf cover.

In another aspect, this document features a product display shelving system for use with a wire shelf, that includes, a side support including a side portion and a top portion, where the top portion couples to an underside of a wire shelf, where the side support further includes a wall engagement member configured to couple to the side portion, and a fence configured to couple to a side of the wire shelf.

In some cases, the product display shelving system also includes a price channel assembly that couples to the fence. In some cases, the price channel includes a price channel support that couples to the fence, and a price channel that couples to the price channel support. In some cases, the price channel can receive a price tag. In some cases, the wall engagement member can include a first aperture and a second aperture that couple to the side portion. In some cases, the first aperture and the second aperture provide a plurality of coupling configurations with the side portion. In some cases, the plurality of coupling configuration cause the side portion to be coupled to the wall engagement member at a plurality of angles. In some cases, the wall engagement member includes a wall coupling protrusion. In some cases, the wall coupling protrusion is hook-shaped. In some cases, product display shelving system also includes a shelving cover that fits over the wire shelf.

In another aspect, this document features a product display shelving system for use with a wire shelf, that includes, a fence configured to couple to a side of the wire shelf and a shelving cover configured to fit over the wire shelf.

In some cases, the product display shelving system includes a price channel assembly configured to couple to the fence. In some cases, the price channel assembly includes a price channel support configured to couple to the fence, and a price channel configured to couple to the price channel support. In some cases, the price channel is configured to receive a price tag. In some cases, the product display shelving system can also include a side support with a side portion and a top portion, where the top portion is configured to couple to an underside of a wire shelf, and where the side support further includes a wall engagement member configured to couple to the side portion. In some cases, the wall engagement member includes a first aperture and a second aperture configured to couple to the side portion. In some cases, the first aperture and the second aperture are configured to provide a plurality of coupling configurations with the side portion. In some cases, the plurality of coupling configuration cause the side portion to be coupled to the wall engagement member at a plurality of angles. In some cases, the wall engagement member includes a wall coupling protrusion. In some cases, the wall coupling protrusion is hook-shaped.

Particular embodiments of the subject matter described in this document can be implemented to realize one or more of the following advantages. First, the side supports can support the wire shelf, and provide versatility in the coupling of the wire shelf to a wall. For example, the side supports can support the wire shelf at an angle. Second, a fence can aid in preventing products from falling off the wire shelf. Third, a price channel can be coupled to the fence to receive price tags for display. Fourth, a cover can be placed over the wire shelf to provide additional advantages, such as different colors, levels of hardness, different textures, different coefficients of friction, or a combination of the previous features.

Unless otherwise defined or explained, all technical and scientific terms used herein have the same meaning as commonly understood by one of ordinary skill in the art to which this disclosure pertains. Methods and materials are described herein for use in the present disclosure; other, suitable methods and materials known in the art can also be used. All publications, patent applications, patents, database entries, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a perspective view of a product display shelving system, in accordance with some embodiments provided herein.

FIG. 2 shows an exploded view of the product display shelving system of FIG. 1, in accordance with some embodiments provided herein.

FIG. 3 shows a close up view of a side support of the product display shelving system of FIG. 2, in accordance with some embodiments provided herein.

FIG. 4 shows a close up view of a fence and price channel system of the product display shelving system of FIG. 2, in accordance with some embodiments provided herein.

FIG. 5 shows a perspective view of the product display shelving system of FIG. 1, with a shelf cover, in accordance with some embodiments provided herein.

FIG. 6 shows an exploded view of the product display shelving system with a shelf cover of FIG. 5, in accordance with some embodiments provided herein.

Like reference numbers represent corresponding parts throughout.

### DETAILED DESCRIPTION

This document provides product display systems for displaying merchandise. In some cases, product display systems described herein can be used to display products to consumers. For example, products displayed on product display systems described herein can include, without limitation, refrigerated or frozen food items or non-food items.

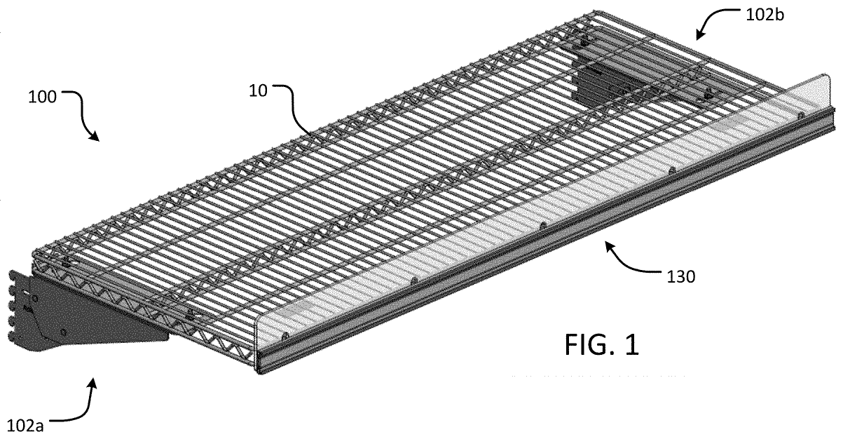

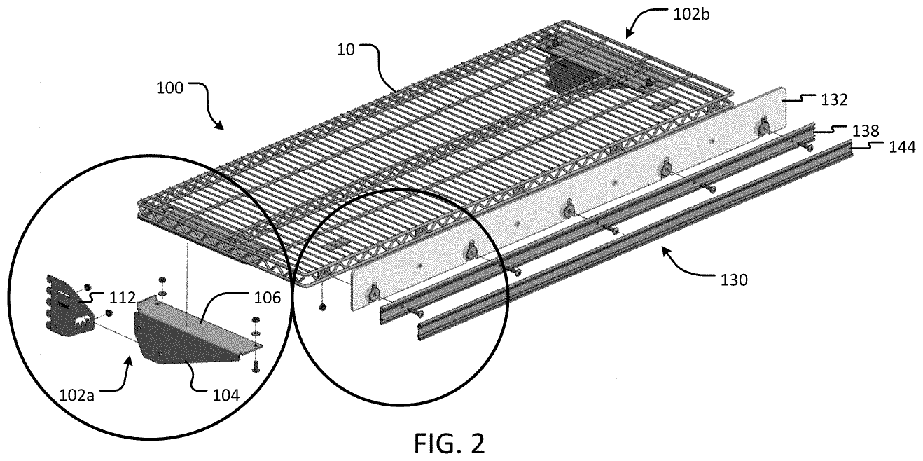

Referring to FIGS. 1-4, a product display shelving system 100 can include side supports 102a and 102b, and a fence and price channel system 130, each of which can be coupled to a wire shelf 10.

Wire shelf 10 can be a standard wire shelf with a plurality of wires forming a top, and sides that extend below the top. In some cases, wire shelf 10 can include a side support coupler 120. Side support coupler 120 can be configured to couple a side support 102a or 102b such that wire shelf 10 can be attached to a wall. Side support coupler 120 can provide apertures to couple to side support 102a or 102b.

Side support 102a, and similarly 102b, can include a side portion 104 that extends substantially perpendicular to the top of wire shelf 10, and can also include a top portion 106 that extends substantially parallel to the top of wire shelf 10. Side portion 104 and top portion 106 can be formed as a single unit. Top portion 106 can provide a surface for wire shelf 10 to rest upon. In some cases, top portion 106 can include a mechanism 108 for coupling top portion 106 to side support coupler 120. For example, mechanism 108 can include apertures in top portion 106 and a fastener. In some cases, the fastener can be a screw and nut, optionally including a washer, or another form of securing fastener, such as a snap.

Side portion 104 can be used to support wire shelf 10 and can include coupling apertures 110. Coupling apertures 110 can allow side portion 104 to couple wall engagement member 112.

Wall engagement member 112 can engage with a wall or wall type structure to aid in hanging wire shelf 10. In some cases, wall engagement member 112 includes a first coupling aperture 114 extending horizontally across wall engagement member 112 that provides coupling to the side portion 104 via aperture 110a. By providing a horizontal aperture for first coupling aperture 114, side portion 104 (and therefore wire shelf 10) can be coupled at a variety of distances from the wall. Such a configuration can be beneficial in providing diversity among shelves, and/or accommodating different sizes of wire shelves 10 with the same bracket. For example, a larger shelf may need to be positioned differently along the first coupling aperture 114 to sit flush against the wall.

In some cases, wall engagement member 112 can include a second coupling aperture 116 that can extend at an angle along wall engagement member 112. Second coupling aperture 116 can couple to aperture 110b of the side portion 104. In some cases, second coupling aperture 116 can be shaped with ridges and valleys along a lower portion of the second coupling aperture 116. The ridges and valleys can allow coupling of the side portion 104 to be modified between different positions. In some cases, different positions of coupling between the side portion 104 and the wall engagement member 112 can cause side portion 104 (and accordingly top portion 106) to be positioned at an angle. Such an angle can cause wire shelf 10 to be positioned at an angle, providing a wider range of display possibilities for product display shelving system 100.

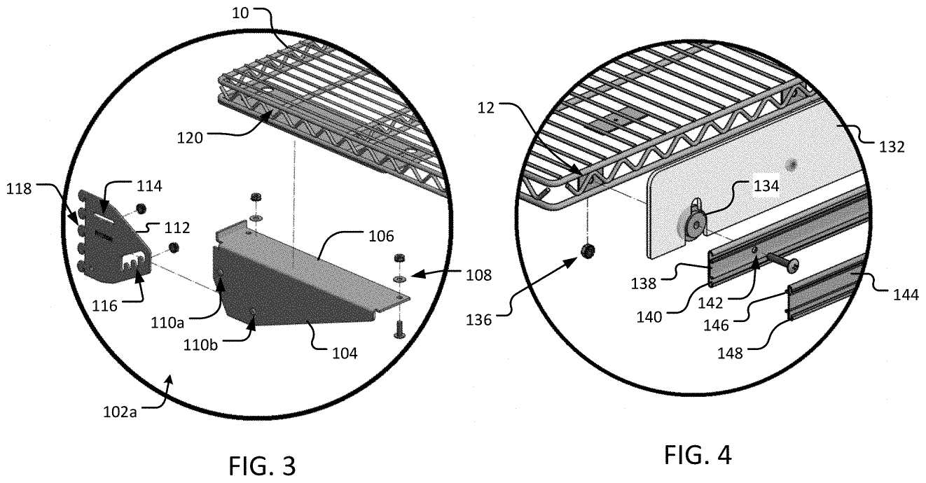

In some cases, wall engagement member 112 can include wall coupling protrusions 118 positioned on a side of wall engagement member 112 opposite second coupling aperture 116. The wall coupling protrusions 118 can be configured to engage with a wall to hang the product display shelving system 100. For example, the wall coupling protrusions 118 can be a plurality of hooks to engage with apertures of the wall. In some cases, the wall can have a plurality of apertures to receive the plurality of hooks, such that each of the wall coupling protrusions 118 engages with an aperture. In some cases, while five wall coupling protrusions 118 are shown in FIG. 3, more or less wall coupling protrusions 118 can be provided.

Fence and price channel 130 can include a fence 132 and a price channel 144. Fence 132 can extend along a portion, or all, of wire shelf 10 and can aid in preventing products from falling off wire shelf 10. In some cases, fence 132 can have a height to aid in holding products on wire shelf 10, without substantially obstructing a view of the product. In some cases, fence 132 can be transparent or opaque to allow the portion to show through fence 132. In some cases, fence 132 can include rounded top edges. In some cases, fence 132 can include engagement 134 that aids in coupling fence 132 to wire shelf 10. In some cases, wire shelf 10 can include a coupling member 12 to couple fence 132. In some cases, coupling member 12 can be included on wire shelf 10. In some cases, coupling member 12 is attached to wire shelf 10 via glue, or another adhesive.

Engagement 134 can aid in securing fence 132 to wire shelf 10. In some cases, engagement 134 can provide a snap fit in fence 132. In some cases, fence 132 can be removed from engagement 134 without disengaging engagement 134. Engagement 134 can also aid in coupling a price channel support 138 to wire shelf 10. For example, engagement 134 can include an aperture that can receive a fastening mechanism 136. Fastening mechanism 136 can be a screw and nut, or another type of fastener.

Price channel support 138 can couple to engagement 134 and therefore to wire shelf 10 via apertures 142. In some cases, price channel support 138 can extend along a portion of, or the entire length of, wire shelf 10. Price channel support 138 can include a price channel support coupler 140 that is configured to couple a price channel 144. Price channel support 138 can define a groove, or ridges defining a groove, that is configured to receive a price channel coupler 146.

Price channel 144 can extend along a portion of, or the entire length of, wire shelf 10, and price channel support 138. Price channel 144 can include a price channel coupler 146 and a price tag holder 148 on opposite faces of the price channel 144. In some cases, price channel coupler 146 couples with price channel support coupler 140. In some cases, price channel coupler 146 can be one or more protrusions that are configured to be received by the groove of price channel support coupler 140. In some cases, the coupling of price channel coupler 146 and price channel support coupler 140 can couple with a snap configuration. In some cases, when the price channel 144 is coupled to the price channel support 138, the price channel 144 covers the fastening mechanism 136, such that the fastening mechanism 136 is not accessible. In some cases, the price channel coupler 136 can create a groove by extending away from the price channel support 138, such that when the price channel 144 is coupled to price channel support 138, a gap is defined. The gap can provide space for fastening mechanism 136 without obstruction between price channel support 138 and price channel 144.

Price tag holder 148 can include an upper support and a lower support that are open on either end. Accordingly, price tag holder 148 can receive price tags and secure a top and bottom of the price tag.

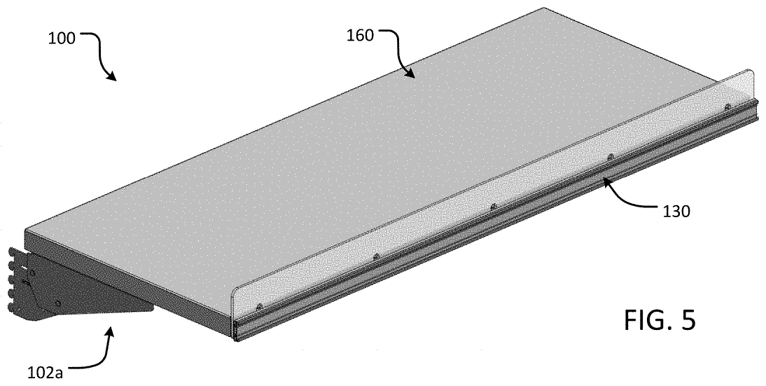

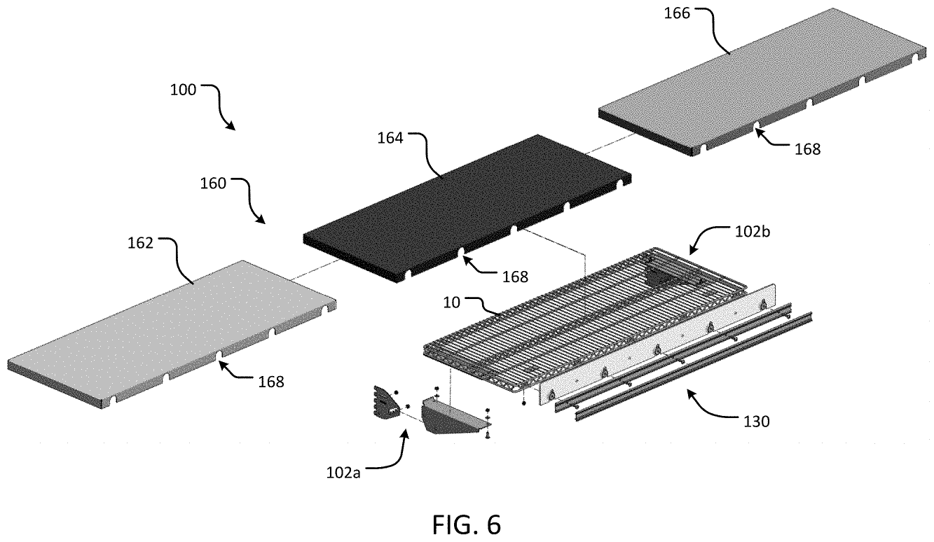

Referring to FIGS. 5 and 6, the product display shelving system 100 can include a shelving cover 160. In some cases, a variety of shelving cover options are available. For example, shelving covers 162, 164, and 166 can be different colors. As another example, shelving covers 162, 164, and 166 can have different textures, and therefore different coefficients of friction. Varying coefficients of friction can be beneficial in displaying select products. For example, if a product has a low coefficient of friction, a shelving cover 162, 164, or 166 can be selected with a high coefficient of friction to increase friction between the product and the shelving cover 160, such that products are less likely to move around on the product display shelving system 100. In some cases, a shelving cover 162, 164, or 166 can be selected with a low coefficient of friction when the product has a high coefficient of friction, such that removing the product from the product display shelving system 100, or moving the product along the product display shelving system 100 is not unnecessarily difficult.

In some cases, the shelving covers 162, 164, and 166 can have different levels of hardness. For example, a softer material cover can be beneficial to use when the product is breakable (e.g., glass or ceramic), while a harder material cover can be used for less fragile products. In some cases, multiple shelving covers 160 can be used in combination. For example, shelving cover 162 can be placed on the wire shelf 10 first, and then covered with shelving cover 164. Such a configuration can be beneficial in providing a softer first shelving cover, while maintaining a more rigid surface that interacts with the product by providing a harder second shelving cover.

In some cases, the shelving covers 162, 164, and 166 can be rated for different temperatures. For example, some shelving covers 160 may be more suited for low temperatures than other shelving covers. In some cases, the shelving covers 160 may be made of a material that is less prone to breaking or cracking when exposed to temperatures common for storing goods in a freezer or refrigerator.

In some cases, the shelving covers 162, 164, and 166 can include recesses 168 that allow the shelving cover 160 to fit over the wire shelf 10, and between the wire shelf 10 and the fence and price channel system 130. In some cases, the shelving cover 160 can be placed on wire shelf 10, without disengaging the fence and price channel system 130. In some cases, the fence and price channel system 130 is loosened or completely removed when attaching or removing the shelving cover 160, such that the shelving cover 160 is secured between the wire shelf 10 and fence and price channel system 130.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single product or packaged into multiple products.

Particular embodiments of the subject matter have been described. Other embodiments are within the scope of the following claims. For example, the actions recited in the claims can be performed in a different order and still achieve desirable results. As one example, the process depicted in the accompanying figures do not necessarily require the particular order shown, or sequential order, to achieve desirable results. In certain implementations, multitasking and parallel processing may be advantageous.

1. A product display shelving system, comprising:
a wire shelf having a top and four sides extending below the top;
a side support comprising a side portion and a top portion, wherein the top portion is configured to couple to an underside of a wire shelf, wherein the side support further comprises a wall engagement member configured to couple to the side portion;
a shelving cover sized to fit over the wire shelf to cover the top and at least two sides of the four sides; and
a fence configured to couple to one of the sides of the wire shelf.

2. The product display shelving system of claim 1, further comprising a price channel assembly configured to couple to the fence.

3. The product display shelving system of claim 2, wherein the price channel assembly comprises a price channel support configured to couple to the fence, and a price channel configured to couple to the price channel support, wherein the price channel is configured to receive a price tag.

4. (canceled)

5. The product display shelving system of claim 1, wherein the wall engagement member comprises a first aperture and a second aperture configured to couple to the side portion.

6. The product display shelving system of claim 5, wherein the first aperture and the second aperture are configured to provide a plurality of coupling configurations with the side portion, wherein the plurality of coupling configuration cause the side portion to be coupled to the wall engagement member at a plurality of angles.

7. (canceled)

8. The product display shelving system of claim 1, wherein the wall engagement member comprises a wall coupling protrusion, wherein the wall coupling protrusion is hook-shaped.

9. (canceled)

10. (canceled)

11. A product display shelving system for use with a wire shelf that has a top and four sides, comprising:
a fence configured to couple to a side of the wire shelf; and
a shelving cover configured to fit over the wire shelf to cover the top and at least two sides of the four sides.

12. The product display shelving system of claim 11, further comprising a price channel assembly configured to couple to the fence.

13. The product display shelving system of claim 12, wherein the price channel assembly comprises a price channel support configured to couple to the fence, and a price channel configured to couple to the price channel support, wherein the price channel is configured to receive a price tag.

14. (canceled)

15. The product display shelving system of claim 11, further comprising a side support comprising a side portion and a top portion, wherein the top portion is configured to couple to an underside of a wire shelf, wherein the side support further comprises a wall engagement member configured to couple to the side portion.

16. The product display shelving system of claim 15, wherein the wall engagement member comprises a first aperture and a second aperture configured to couple to the side portion.

17. The product display shelving system of claim 16, wherein the first aperture and the second aperture are configured to provide a plurality of coupling configurations with the side portion, wherein the plurality of coupling configuration cause the side portion to be coupled to the wall engagement member at a plurality of angles.

18. (canceled)

19. The product display shelving system of claim 15, wherein the wall engagement member comprises a wall coupling protrusion, wherein the wall coupling protrusion is hook-shaped.

20. (canceled)

21. The product display shelving system of claim 1, wherein the shelving cover covers all four sides of the wire shelf.

22. The product display shelving system of claim 11, wherein the shelving cover covers all four sides of the wire shelf.

23. A product display shelving system, comprising:
a wire shelf with a top and four sides;
a first shelving cover sized to fit over the wire shelf to cover the top and at least two sides of the four sides; and
a second shelving cover sized to fit over the wire shelf to cover the top and at least two sides of the four sides.

24. The product display shelving system of claim 23, wherein the first and second shelving covers are configured to be used in combination such that, while the first shelving cover is fit on the wire shelf, the second shelving cover can be fit over the first shelving cover to cover the first shelving cover.

25. The product display shelving system of claim 23, wherein the first and second shelving covers have differing levels of hardness.

26. The product display shelving system of claim 23, wherein the first and second shelving covers have differing coefficients of friction.
